(19) United States
(12) Patent Application Publication
(10) Pub. No.: US 2023/0367629 A1
(43) Pub. Date: Nov. 16, 2023

(54) Method for Transferring a Software Application from a First to a Second Data Processing Device

(71) Applicant: Siemens Aktiengesellschaft, Muenchen (DE)

(72) Inventors: Jan GÖTZ, Buckenhof (DE); Jürgen REICHMANN, München (DE)

(21) Appl. No.: 18/026,143

(22) PCT Filed: Aug. 31, 2021
(86) PCT No.: PCT/EP2021/073944

§ 371 Date: Mar. 14, 2023

(30) Foreign Application Priority Data
Sep. 15, 2020 (EP) 20196119

(51) Int. Cl. G06F 9/48

(52) U.S. Cl. CPC G06F 9/4856

(57) ABSTRACT

Method for transferring a software application between first and second data processing devices includes executing a first software application instance in the first data processing device, data communication by the first software application instance with a further software application and/or an apparatus occurring, and internal state data of the first data processing device and/or regarding an internal execution of the first software application instance being stored, transferring launch state data available in the first data processing device at a first time to a second memory device communicatively coupled to the second data processing device, launching a second software application instance, at a second time via the launch state data, such that the first and second software application instances are executed in sync at a subsequent third time, and handing over data communication with the further software application or apparatus from the first to second software application instance.

### CROSS-REFERENCE TO RELATED APPLICATIONS

This is a U.S. national stage of application No. PCT/EP2021/073944 filed 31 Aug. 2021. Priority is claimed on European Application No. 20196119.0 filed 15 Sep. 15, 2020, the content of which is incorporated herein by reference in its entirety.

### BACKGROUND OF THE INVENTION

### 1. Field of the Invention

The present invention relates to a method for transferring a software application from a first to a second data processing device,

with, within the execution of a first instance of the software application implemented on the first data processing device, there being a data communication between the first instance of the software application and a further software application and/or an apparatus.

### 2. Description of the Related Art

Methods for transferring a software application from a first to a second data processing device are known from the prior art. For example, the laid-open application EP 3 611 579 A1 discloses a real-time automation device with a real-time data bus, via which various applications installed on the real-time automation device are coupled. The communication of data via the real-time data bus is implemented by way of “bus variables”, to which these data are respectively assigned. Here, which applications supply values for which of the bus variables is stored in a bus database of the real-time data bus. By way of a synchronization of the respective bus databases to two real-time data buses present in various real-time controllers, EP 3 611 579 A1 furthermore discloses the option of moving an application from one real-time controller to the other.

A disadvantage of the prior art is that the real-time synchronization of different real-time controllers, in particular of the associated real-time databases, can be complicated and error-prone (especially in the case of quite sophisticated real-time demands). By way of example, this renders the move of a software application between such real-time controllers complicated and error-prone.

### SUMMARY OF THE INVENTION

In view of the foregoing, it is therefore an object of the present invention to provide an improved method and/or an improved apparatus for moving a software application between different data processing apparatuses.

This and other objects and advantages are achieved in accordance with the invention by a method which is implemented in a manner so as to transfer a software application from a first to a second data processing device and comprises:
a) executing a first instance of the software application implemented on the first data processing device, where the scope of execution of the first instance of the software application within the first data processing device includes the implementation of data communication between the first instance of the software application and a further software application and/or an apparatus, and includes the storage of state data in relation to an internal state of the first data processing device and/or in relation to an internal execution of the first instance of the software application in a first storage device;
b) transferring launch state data available on the first data processing device at a first time to a second storage device communicatively coupled to the second data processing device;
c) launching a second instance of the software application, implemented on the second data processing device, at a second time using the launch state data, where the second instance of the software application is then executed on the second data processing device such that, at a third time following the second time, the first instance of the software application on the first data processing device and the second instance of the software application on the second data processing device are executed synchronously; and
d) handing over data communication with the further software application or apparatus from the first instance of the software application implemented on the first data processing device to the second instance of the software application implemented on the second data processing device.

An advantage of the disclosed method is that it enables an at least substantially interruption-free and/or hitch-free move of the software application from the first to the second data processing device. In particular, the disclosed method may also enable an interruption-free and/or hitch-free move of the software application from the first to the second data processing device.

This is achieved, at least inter alia, by the state data stored during the execution of the software application being collected at a certain time and subsequently being transferred to the second data processing device. Then, the second instance of the software application is launched there at a later time using the transferred state data. Subsequently, this further instance of the software application is “fast forwarded”, as it were, to be precise until the first and second instance of the software application executes synchronously.

In this way, the disclosed method allows a substantially hitch-free or interruption-free move of the software application from the first to the second data processing device, for example, even if significant real-time demands exist, because the “fast-forward mechanism” means that it is not necessary to transfer state data from the first to the second data processing device in real time.

Here, hitch-free and/or interruption-free is, for example, understood to mean that the functionality of the software application is not interrupted, even while the software application is moved from the first to the second data processing device. By way of example, this can be configured so that the move from the first to the second data processing device is not noticeable in an externally visible effect of the software application.

Here, the hitch-free and/or interruption-free move of the software application from the first to the second data processing device can be, for example, configured so that the change in the functionality of the software application from the first to the second data processing device is executed quicker than usual or defined control, reaction or response times, which are provided or expected for such applications.

Here, the change in the functionality of the software application is understood to mean that the (e.g., externally visible) generation of the effect of running the software application changes from executing the first instance of the software application by the first data processing device to executing the second instance of the software application by the second data processing device.

By way of example, such a move can be performed faster than a maximum response time given by a real-time specification. If a cyclical program execution is provided for executing the software application, such a move of the functionality of the software application from the first to the second data processing device may be performed, for example, within the scope of an associated cycle time, or else faster than an associated cycle time.

The first and/or second data processing device may have a mobile or else stationary configuration, for example. By way of example, the data processing device can be configured as a computer, a personal computer (PC), a workstation, a smartphone, a tablet computer, a computer network, a cloud, a control device, a controller, a programmable logic controller or as comparable equipment or devices.

Furthermore, the first and/or second data processing device may comprise a housing, for example. By way of example, the first and/or second data processing device can each be configured as a separate structural unit. Furthermore, the first and/or second data processing device can each also be configured as a logical and/or functional unit within a larger overall system (e.g., as a “data processing device app” in a cloud).

The first storage device for storing the state data can be provided, for example, on the first data processing device or else on a further data processing device or external data memory communicatively connected to the first data processing device.

External data memories communicatively connected to the first data processing device can be provided and/or implemented, for example, in a further data processing device, a computer network, a cloud, an external electronic memory (memory card, microchip, and/or USB stick), an external electronic mass storage (e.g., hard disk drive, or SSD, . . . ) or in comparable devices.

Here, the storage device and/or the module storage device can be configured as an electronic storage device or digital storage device.

By way of example, such a storage device can be formed as a non-volatile data memory (“non-volatile memory”), which is configured for permanent or long-term data storage. By way of example, such storage devices can be SSD memories, SSD cards, hard disk drives, CDs, DVDs, EPROMS or flash memories or comparable storage devices.

Furthermore, a storage device can also be configured as a volatile memory. By way of example, such memories can be configured as what is known as DRAM or dynamic RAM (“dynamic random access memory”) or SRAM (“static random access memory”).

A storage device with stored data and/or information can also, for example, be as an integrated circuit, in which at least, inter alia, the data and/or information are implemented.

Here, the data communication between the first instance of the software application and the further software application and/or the apparatus can be performed via an internal and/or an external data bus, for example. Likewise, the data communication between the second instance of the software application and the further software application and/or the apparatus can be performed via an internal and/or external data bus, for example. By way of example, each of the first and/or second data processing device may comprise an appropriate internal data bus.

By way of example, a data bus may be configured as what is known as a fieldbus or else have a proprietary and/or internal communications data format and/or communications protocol.

By way of example, the data bus may have a data area jointly used by the communication partners that communicate via the data bus. By way of example, this jointly used data area can be configured for (buffer) storage of data to be communicated, communicable data and/or data in the communications process. By way of example, such a jointly used data area can be configured as what is known as a “shared memory” or what is known as a “dual port RAM”.

The further software application can be any software application. By way of example, the further software application can be designed and configured for communication with at least one other software application. Here, the further software application may be implemented, for example, on the first, the second or a further data processing device.

By way of example, the apparatus can be configured as a module, a component or an installation. By way of example, the apparatus may furthermore be configured as a machine, a piece of equipment, a robot, a production line or something comparable, or may comprise such parts as components. By way of example, such an apparatus or installation may comprise one or more components, modules, drives, sensors, machines, pieces of equipment, and/or communications devices.

By way of example, state data can be internal state data relating to the software application and/or the execution of the software application or can be internal data. By way of example, such internal data can be counters, flags, and/or state data. By way of example, state data may be data necessary temporarily for an intended execution of a software application.

By way of example, state data may also describe an internal state of the software application and/or of the execution of the software application. Within this meaning, state data can, for example, describe the execution step, the iteration, the execution state, or the like, of the software application.

State data may be auxiliary data that are required or used for the intended execution of the software application. Such state data are frequently stored only internally and, as a rule, are purely state-afflicted elements.

In an advantageous embodiment, the state data is labeled separately. By way of example, this labeling can be performed by a system for the creation of such a software application or can be configured, for example, by an engineering system. By way of example, the label can be stored together with the state data or in a separate file or a separate memory area. Furthermore, the state data can be stored separately, such as in a separate file, a separate memory area, and/or a separate storage device.

Launch state data within the meaning of the present disclosure are those state data in accordance with the disclosed embodiments with respect to an internal state of the first data processing device and/or with respect to an internal execution of the first instance of the software application, which state data were or are stored on the first storage device of the first data processing device at the first time.

Here, the launch state data can be transferred, for example, from the first to the second data processing device and/or from the first storage device to the second storage device.

Here, the communicative coupling of the second storage device to the second data processing device can be configured such that the second data processing device comprises the second storage device. Furthermore, this communicative coupling can also be configured so that the second storage device is provided in an external data memory that is communicatively connected to the second data processing device.

By way of example, such external data memories that are communicatively connected to the second data processing device can be provided and/or implemented on a further data processing device, a computer network, a cloud, an external electronic memory (e.g., memory card, microchip, or USB stick), an external electronic mass storage (e.g., hard disk drive, or SSD) or comparable devices.

Here, the aforementioned storage devices could furthermore be configured in accordance with the disclosed embodiments.

Furthermore, the second time can be, for example, equal with the first time or temporally follow the first time.

By way of example, the second instance of the software application can be executed on the second data processing device in method step c) in accordance with the disclosed embodiments such that the execution is performed faster than the parallel execution of the first instance of the software application on the first data processing device. What this can achieve is that the second instance of the software application executes synchronously with the first instance of the software application at the specified third time despite the second instance of the software application launching on the second data processing device with the launch state data at a later time than the first instance of the software application launched on the first data processing device. In a certain sense, this can be considered to be a “fast forwarding” of the second instance of the software application until both instances of the software application run synchronously.

The faster execution of the second instance of the software application can be achieved, for example, by using a different timing cycle, a change in time basis, a reduction in a cycle time, a change in the control flow scheme, the use of a further time basis or comparable mechanisms.

By way of example, the third time can be the time at which the first and second instance of the software application execute synchronously for the first time. Further, the third time may also be a time after the first-time synchronous execution of the first and second instance of the software application.

In an advantageous embodiment, the execution of the second instance of the software application on the second storage device of the second data processing device to be then implemented such that, after a third time that follows the second time, the first instance of the software application on the first storage device of the first data processing device and the second instance of the software application on the second storage device of the second data processing device execute synchronously.

The handover of the data communication with the further software application or the apparatus from the first instance of the software application to the second instance of the software application can be performed, for example, at the third time or at a time following the third time.

Here, the handover can be implemented, for example, such that, within the scope of the handover, the communication of the first instance of the software application with the further software application or apparatus is terminated and the communication of the second instance of the software application with the further software application or the apparatus is launched.

Terminating the communication of the first instance of the software application with the further software application or the apparatus and launching the communication of the second instance of the software application with the further software application or the apparatus can, for example, be performed simultaneously or within a predefined or pre-definable time window. In this case, the predefined or pre-definable time window may correspond to a switchover time, for example. The absolute value of such a switchover time may, for example, be given or determined by real-time requirements or other requirements with respect to an interruption-free or hitch-free switchover.

In an advantageous embodiment, a method in accordance with the present disclosure can be implemented such that input data for the further software application and/or apparatus and/or output data for the further software application and/or apparatus are stored during the data communication within the scope of method step a), such that a tracing process for storing respectively current input and/or output data in an I/O tracing database is launched in a further method step al) which precedes method step b), and such that launching of the second instance of the software application within the scope of method step c) is further implemented using input and/or output data stored in the I/O tracing database in relation to the first time.

The presently contemplated embodiment of the invention further simplifies the handover of the software application from the first to the second data processing apparatus. As a result of input data and/or output data used for an operation of the software application being stored in an I/O tracing database, the “fast forwarding” of the second instance of the software application on the second data processing device is further simplified.

When the second instance of the software application is launched on the second data processing device, the input data and/or output data available at the first time from the I/O tracing database are taken into account in addition to the launch state data assigned to the first time. During the further execution of the second instance of the software application within the scope of method step c), the input data and/or output data temporally matching the corresponding state data taken from the I/O tracing database are then respectively taken into account, and hence a correct fast forwarding or execution of the second instance of the software application to the third time is achieved.

Here, input data are those data that are transferred from the further software application and/or the apparatus to the software application. As a rule, such input data are used within the scope of the execution of the software application.

Here, output data are those data that are transferred from the software application to the further software application and/or the apparatus. As a rule, such output data are used for the execution or configuration of the further software application and/or the control or operation of the apparatus. By way of example, input and/or output data in relation to the further software application can be those data that are exchanged or should be exchanged between the software application and the further software application.

Input and/or output data in relation to the apparatus can be, for example, data that come from a machine or installation within the scope of the control thereof (e.g., sensor data, machine state data or characteristic data) or that are sent to the said machine or installation (e.g., control data for actuators or for adjusting or setting equipment parameters).

By way of example, if the data processing device is designed and configured as a programmable logic controller, then input and/or output data can be stored in what is known as a process image of the programmable logic controller, for example.

In an advantageous embodiment, the I/O tracing database can be stored on the first or second data processing device, for example.

By way of example, the storage of the respectively current input and/or output data can be designed and configured so that, for example, at periodically or regularly successive times, the respectively current input and/or output data are stored in the I/O tracing database. The period or the cycle for storing the respective input and/or output data may, for example, be defined or adjustable, for example, by a user or else an automatism.

In the case of a cyclical program design of the software application, for example, the respectively current input and/or output data can be stored in the I/O tracing database once per program cycle. In particular, this may occur between two program cycles in each case.

Storage of the respectively current input and/or output data in the I/O tracing database can, for example, be performed such that each time at which the data were present is stored with the individual input and/or output data. Furthermore, the input and/or output data can also be stored in the I/O tracing database such that input and/or output data present at a certain time are stored as a data set in the I/O tracing database, and this data set is assigned the time at which these data were present.

The specified time at which the respective input and/or output data were present can, for example, be detected and/or assigned by the first data processing apparatus, a runtime environment of the first instance of the software application or else, for example, of the I/O tracing database or an operating system assigned thereto.

The I/O tracing database may be available, for example, in an SQL format or else in what is known as a NoSQL format. Here, the database or the storage in the database can be configured in accordance with the disclosed embodiments or may comprise components in accordance with the disclosed embodiments.

Launching of the second instance of the software application within the scope of method step c) using the input and/or output data stored in relation to the first time in the I/O tracing database may, for example, be configured so that, when launching the second instance of the software application within the scope of method step c), the launch state data in relation to the first time and the input and/or output data in relation to the first time are taken as the data to be used for the startup of the second instance of the software application.

Furthermore, at least one time value can be assigned to each input and/or output datum stored in the I/O tracing database.

Each I/O datum can be stored in the I/O tracing database with a time value at which it was effectively available. By way of example, this time value can be ascertained and/or assigned by the first data processing device. Furthermore, the time value can also be ascertained and/or assigned by the second data processing device, for example.

In the process, a time value can be assigned to each input and/or output datum, for example. Furthermore, a time value can be assigned to a group of input and/or output data that were present at the same time.

Such time values are frequently also referred to as “timestamps”.

Furthermore, the time value associated with the respective input and/or output data can be registered by the first or second data processing device, can then be assigned to the respective input and/or output data, and can then be stored with the associated data in the I/O tracing database. Alternatively, the time value can also be registered within the scope of storing the respective input and/or output data in the I/O tracing database and can be assigned to the respective data. By way of example, the registration and assignment can be implemented by the I/O tracing database or in a runtime environment in which the database runs.

The object and advantages in accordance with the invention are also achieved by a method for transferring a software application from a first to a second data processing device, comprising:
A1) executing a first instance of the software application implemented on the first control device, where the scope of execution of the first instance of the software application within the first data processing device includes implementation of data communication between the first instance of the software application and a further software application and/or an apparatus, storing, within the data communication, of input data of the further software application and/or apparatus and/or of output data for the further software application and/or apparatus, and storing state data in relation to an internal state of the first data processing device and/or in relation to an internal execution of the first instance of the software application in a first storage device;
B1) launching a tracing process for storing respectively current input and/or output data in an I/O tracing database;
C1) transferring launch state data available on the first data processing device at a first time to a second storage device communicatively coupled to the second data processing device;
D1) launching a second instance of the software application, implemented on the second data processing device, at a second time using the launch state data and input and/or output data in relation to the first time stored in the I/O tracing database, where the second instance of the software application is then executed on the second data processing device such that, at a third time following the second time, the first instance of the software application on the first data processing device and the second instance of the software application on the second data processing device are executed synchronously;
E1) handing over data communication with the further software application or apparatus from the first instance of the software application implemented on the first data processing device to the second instance of the software application implemented on the second data processing device.

In an advantageous embodiment, the method in accordance with the invention is configured such that the data communication with the further software application and/or the apparatus is executed in interruption-free manner.

Here, interruption-free is understood to mean, for example, that the communication of the software application with the further software application and/or the apparatus is not interrupted taking account of the usual or defined time tolerances within the scope of this communication. By way of example, this can be configured so that an externally visible effect of the software application remains substantially unchanged despite a move from the first to the second data processing device.

By way of example, the aforementioned time tolerances can be maximum response times and/or reaction times specified within the scope of a communications standard or a definition of a communications protocol or an implementation of a communications standard or communications protocol. By way of example, the corresponding data communication can be considered to be interruption-free if a communication partner can perform communication with the first or second data processing device that is disturbance-free in this context even during the move of the software application from the first to the second data processing device. This disturbance-free communication relates to, for example, the standards and/or protocols implemented within this data communication, taking into account the corresponding usual accuracies and tolerances.

Furthermore, the method in accordance with the disclosed embodiments can be configured such that the first instance of the software application on the first data processing device and the second instance of the software application on the second data processing device are each executed cyclically.

Here, in general, a cyclic execution of a software application is understood to mean that the software application, once terminated, executes again from the start. Such cyclic executions are frequently used, as a rule, with real-time operating systems and/or real-time controllers of machines or installations. By way of example, a cyclic program execution is frequently used within the scope of the program execution on programmable logic controllers.

In an advantageous embodiment, the cyclic program execution can, for example, be configured such that input data, for example, relevant to the program execution are read before the start of a program cycle, for example, into a specific memory area, and a cycle of the program is then executed using these input data. During or after the end of the program cycle, the output data generated over the course of the program cycle are then written to a specific memory area, for example, and/or are output. This is followed by the next cycle, once again with reading of the next input data.

The time for the execution of a program cycle is frequently referred to as cycle time. The cycle time can be defined in various ways, such as the pure runtime of a program cycle. Further, the cycle time may also be defined as the overall time required for the reading of the input data, the execution of a cycle of the program, and the writing of the output data.

The method in accordance with the disclosed embodiments a can also be configured such that the first and second data processing device each comprise a real-time operating system, with the running of the first instance of the software application on the first data processing device and the execution of the second instance of the software application on the second data processing device being respectively performed within the scope of the respective real-time operating system of the respective data processing device.

In a further advantageous embodiment, the execution of the first instance of the software application on the first data processing device and the execution of the second instance of the software application on the second data processing device can in addition be configured such that the data communication of the respectively active instance of the software application with the further software application and/or the apparatus is configured as a real-time communication.

Very generally, the term real time is understood here to mean the operation of a computer system in which programs for processing arising data are continuously operationally ready in a manner so that the processing results are available within a given time interval. Depending on application, the data may arise according to a temporally random distribution or at predetermined times.

A real-time operating system is understood to mean an operating system for a data processing device which is configured so that queries of a user program or else a signal arriving via a hardware interface can be guaranteed to be processed within a time interval defined or definable in advance. What is essential in this context is that such a guaranteeable time interval exists. The length of this time interval is not essential for the fact that a certain operating system is a real-time operating system.

By way of example, a real-time operating system can be designed and configured as a real-time operating system within the meaning of the DIN 44300 standard.

By way of example, a real-time communication can be configured so that a specified or specifiable real-time requirement is observed. By way of example, such real-time requirements can relate to a transfer bandwidth to be guaranteed, or to a latency time of the transfer to be observed. Here, the real-time communication can be configured, for example, as a real-time ethernet communication, for example, according to the TSN standard. Furthermore, the real-time communication can be configured in accordance with a real-time-capable fieldbus standard.

Furthermore, the first and second instance of the software application can each be configured for real-time data communication with the further software application and/or the apparatus.

In this context, the real-time communication can, for example, configured in accordance with the disclosed embodiments of the invention.

In addition, the data communication can furthermore be performed using a memory area jointly used by the involved communication partners.

Here, for example, a time value can be assigned or assignable to the data stored in the jointly used memory area, or else to groups of such data. Here, “assignable” is understood to mean, for example, that a time value is derivable or derived for example from a further stored variable (e.g., a cycle time and a number of cycles).

By way of example, the jointly used memory area can be configured as what is known as a dual port RAM or as what is known as a “shared memory”.

In a further advantageous embodiment, the data communication is configured for communicating values that are each assigned to variables. In this context, it is possible, for example, to store values, which are assigned to a specific variable and were stored in the jointly used memory area at different times, in a data buffer assigned to the variable.

The involved communication partners are understood to mean the respective partners, software applications, and/or instances taking part in the communication under consideration.

In an advantageous embodiment, the data communication using a jointly used memory area is configured as real-time data communication.

In a further advantageous embodiment, a respective time value is assigned or assignable to data stored in the jointly used memory area within the scope of the communication.

In a further advantageous embodiment, the time value associated with a datum is likewise stored in the jointly used memory area.

The method in accordance with the presently disclosed embodiments can furthermore be configured so that the state data are labeled within the scope of configuring the first instance of the software application on the first data processing device.

By way of example, what is known as an engineering system may be provided, via which, for example, the software application was or can be created, modified, and/or also implemented within the corresponding data processing device. Subsequently, for example, certain data can be labeled as state data via such an engineering system. When implementing or instantiating the software application, this label can then likewise be stored in the corresponding control device and then, for example, be used to identify the state data in accordance with the disclosed embodiments of the method. This labeling can also be performed directly during the implementation or instantiation of the software application.

Furthermore, in an advantageous embodiment, the first and second data processing device can each be configured as a control device for controlling an apparatus or installation.

By way of example, the method in accordance with the presently disclosed embodiments can be advantageously used for moving a software application from a first to a second control device. As a rule, control devices are used for open-loop and/or closed-loop control tasks. Here, real-time demands or failure safety are frequently essential criteria to be satisfied, for example.

Here, the use of the method in accordance with the disclosed embodiments, for example, allows a software application to be moved from the first to the second control device without the functionality of the software application being interrupted. In this way, the method in accordance with the disclosed embodiments can, for example, be configured such that corresponding real-time requirements or response times are ensured in the process, even while the software application is being moved.

By way of example, the control device can be configured as a programmable logic controller (PLC). Furthermore, the control device can also be configured as a modular programmable logic controller (modular PLC).

A control device can be any type of computer or computer system that is configured to control an apparatus or a piece of equipment. A control device can also be a computer, a computer system or what is known as a cloud, on which control software or a control software application, for example, a control application, is implemented or installed. Such a control application implemented in the cloud can be, for example, configured as an application with the functionality of a programmable logic controller.

Furthermore, the control device can also be configured as an edge device, with such an edge device, for example, being able to comprise an application for controlling apparatuses or installations. By way of example, such an application can be configured as an application with the functionality of a programmable logic controller. Here, the edge device can be connected, for example, to a further control device, to an apparatus to be controlled, or to an installation to be controlled. Furthermore, the edge device can be configured such that it is additionally also connected to a data network or a cloud or it is configured for connection to a corresponding data network or a corresponding cloud.

The objects and advantages in accordance with the invention are furthermore achieved by a data processing system comprising a first and second data processing device according to the present description, where the data processing system is configured to transfer a software application from the first to the second data processing device via the method in accordance with the disclosed embodiments.

The data processing devices, the coupling thereof, and the elements or the components thereof may in this case furthermore be configured in accordance with the disclosed embodiments of the invention.

Here, the first data processing device may, for example, comprise the first storage device. Furthermore, the second data processing device may comprise the second storage device.

Furthermore, the first data processing device may comprise a jointly used memory area in accordance with the disclosed embodiments, which is used for data communication with the further software application and/or the apparatus. Furthermore, the second data processing device, may also comprise a jointly used memory area in accordance with the disclosed embodiments, which is used for data communication with the further software application and/or the apparatus.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Below, the present invention is explained in more detail in exemplary fashion, with reference being made to the attached figures, in which:

FIG. 1 shows a schematic 1^{st} work step for an exemplary move, from a first PC to a second PC, of a second software application that communicates with a first software application;

FIG. 2 shows a schematic 2^{nd} work step for an exemplary move, from a first PC to a second PC, of a second software application that communicates with a first software application;

FIG. 3 shows a schematic 3^{rd} work step for an exemplary move, from a first PC to a second PC, of a second software application that communicates with a first software application;

FIG. 4 shows a schematic 4^{th} work step for an exemplary move, from a first PC to a second PC, of a second software application that communicates with a first software application;

FIG. 5 shows a schematic 5^{th} work step for an exemplary move, from a first PC to a second PC, of a second software application that communicates with a first software application;

FIG. 6 shows a schematic 6^{th} work step for an exemplary move, from a first PC to a second PC, of a second software application that communicates with a first software application;

FIG. 7 shows a schematic 7^{th} work step for an exemplary move, from a first PC to a second PC, of a second software application that communicates with a first software application;

FIG. 8 shows a schematic 8^{th} work step for an exemplary move, from a first PC to a second PC, of a second software application that communicates with a first software application;

FIG. 9 shows a schematic 9^{th} work step for an exemplary move, from a first PC to a second PC, of a second software application that communicates with a first software application;

FIG. 10 shows a schematic 1^{st} work step for an exemplary move, from a first PC to a second PC, of a third software application that communicates with a robot; and

FIG. 11 shows a schematic 9^{th} work step for an exemplary move, from a first PC to a second PC, of a third software application that communicates with a robot.

### DETAILED DESCRIPTION OF THE EXEMPLARY EMBODIMENTS

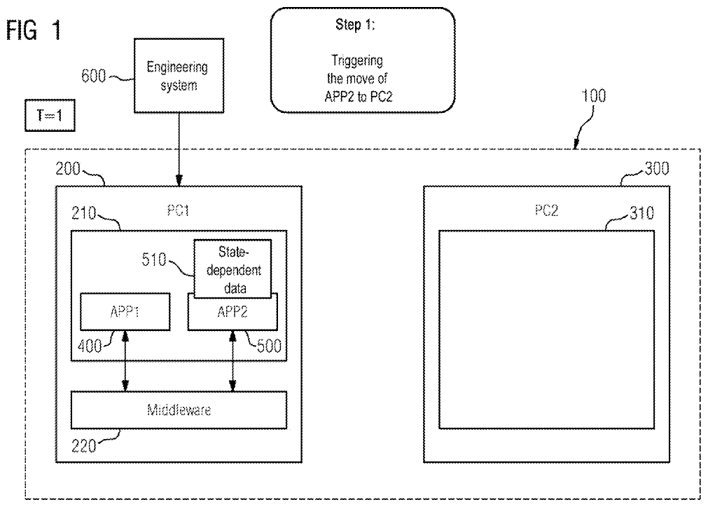

FIGS. 1-9 explained below show a schematic representation of work steps for an exemplary move, from a first PC 200 to a second PC 300 (in this case, PC stands for personal computer), of a second software application 500.

Here, FIG. 1 shows a data processing system 100 that comprises the first PC 200 and the second PC 300. Here, the first PC 200 comprises a first memory device 210, in which a first software application 400 and a first instance of a second software application 500 are stored. Furthermore, state data 510 for the first instance of the second software application 500 are stored in the memory device 210 of the first PC 200. These state data 510 comprise various counters and state variables, which are required for an intended execution of the first instance of the second software application 500.

Furthermore, the first PC 200 comprises “middleware” 220, which comprises a data bus for communication with various software applications within the first PC 200. By way of this middleware 220, the first instance of the second software application 500 communicates with the first software application 400. Furthermore, the middleware 220 also has internal control tasks in relation to process control and communication within the first PC 200.

FIG. 1 furthermore shows an engineering system 600, which is configured to program and set up the first PC 200. In particular, the first software application 400 and the second software application 500 were created and instantiated on the first PC 200 using the engineering system 600. Furthermore, the state data 510 for the first instance of the second software application 500 were specifically labeled as “state data” with the aid of the engineering system 600, in order to be able to distinguish these data from other data stored in the storage device 210 of the first PC 200.

The second PC 300 likewise comprises a storage device 310, where the further properties and the further structure of the second PC 300 are subsequently be described within the scope of the subsequent work steps.

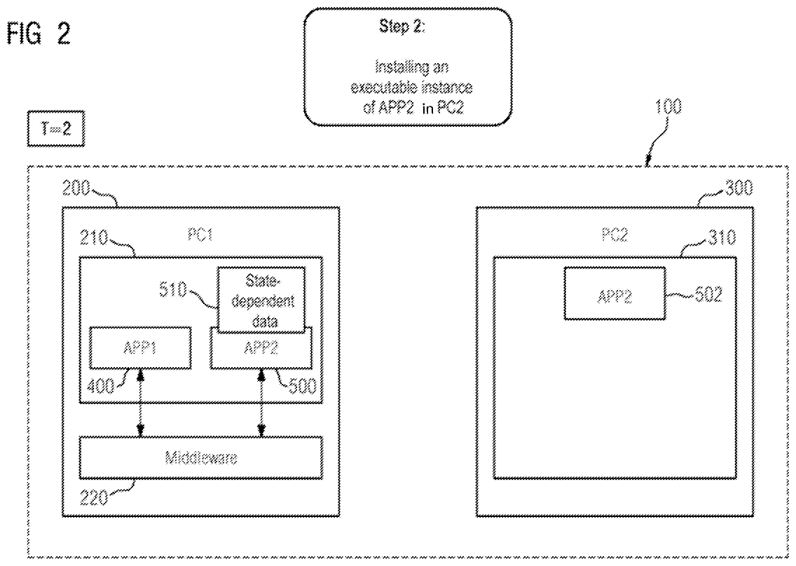

FIG. 1 now shows, at a first time T=1, a first work step for moving the functionality of the second software application 500 to the second PC 300, with the communication to the first software application 400 being maintained. Here, the second software application is moved such that an operation of the first instance of the second software application 500 on the first PC 200 is shifted to the operation of a second instance of the second software application 502 (not depicted in FIG. 1 but only depicted from FIG. 2 onward) on the second PC 300.

In this first step depicted in FIG. 1, there is a trigger command from an external device, for example the engineering system 600, to the middleware 220 of the first PC 200, with this trigger then triggering the process sequence, described in the context of the following figures, for moving the functionality of the second software application 500 from the first PC 200 to the second PC 300.

FIG. 2 shows the result of a second work step at a time T=2. Within this second work step, the aforementioned second instance of the second software application 502 was installed in the storage device 310 of the second PC 300.

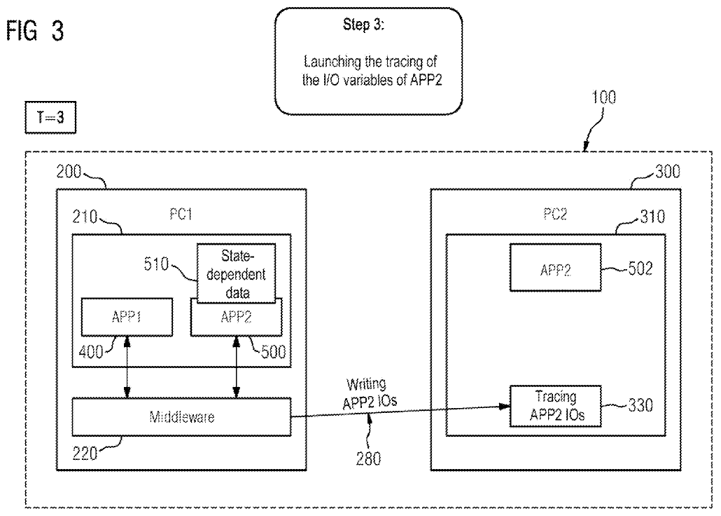

FIG. 3 shows the result of a third work step at a time T=3, with continuous storage in a tracing database 330 of input and output data from the first instance of the second software application 500 being launched in this third work step. Here, the tracing database 330 is stored in the storage device 310 of the second PC 300.

Storage and transfer of the input and output data of the first instance of the second software application 500 to the tracing database 330 is symbolized by an arrow 280 in FIG. 3.

From this launch time T=3, this storage of the respectively current input and output data in the tracing database 330 is implemented continuously, even at the later times, provided this is noted in the corresponding figures and/or the corresponding description.

Within the scope of this launched tracing of the input and output data of the first instance of the second software application 500, the times at which the respective input and output data were present on the first PC 200 are each also stored in the tracing database 330 with the respective input and output data. In this way, the time at which the respective data were present on the first PC 200 is evident for all input and output data stored in the tracing database 330.

Both the first PC 200 and the second PC 300 are configured for a cyclic program execution of the software applications 400, 500, 502 executing thereon. Here, the cyclic program execution is performed in each case with a defined or definable cycle time. Here, storage of the respectively current input and output data of the first instance of the second software application 500 are each performed between two program cycles of the execution of the first instance of the second software application 500 on the first PC 200.

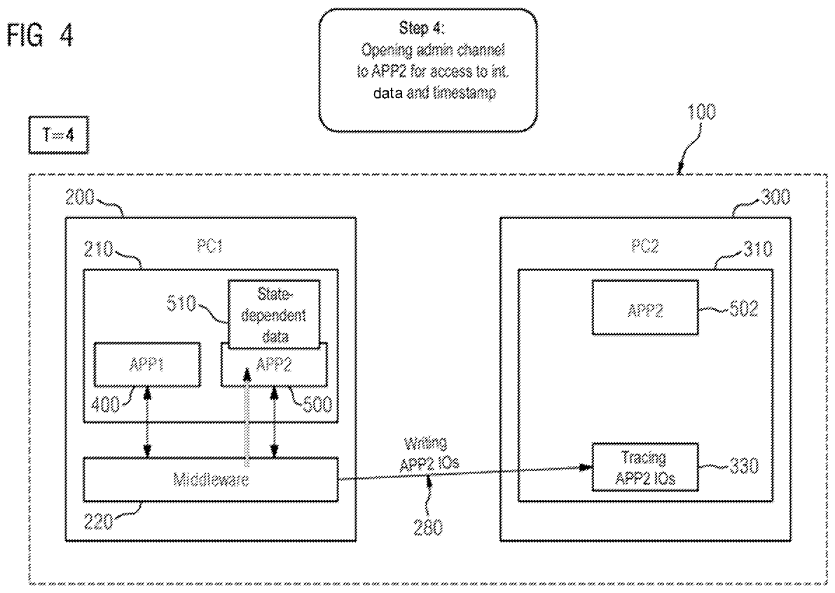

FIG. 4 represents the result of a fourth work step at a time T=4, after a control channel from the middleware 220 to the first instance of the second software application 500 was opened. This opening of the control channel is symbolized in FIG. 4 by a double-headed arrow from the middleware 220 to the first instance of the second software application 500.

By way of this control channel, the middleware 220 can now access the internal data and timestamp of the first instance of the second software application 500, in particular also state data 510 of the first instance of the second software application 500.

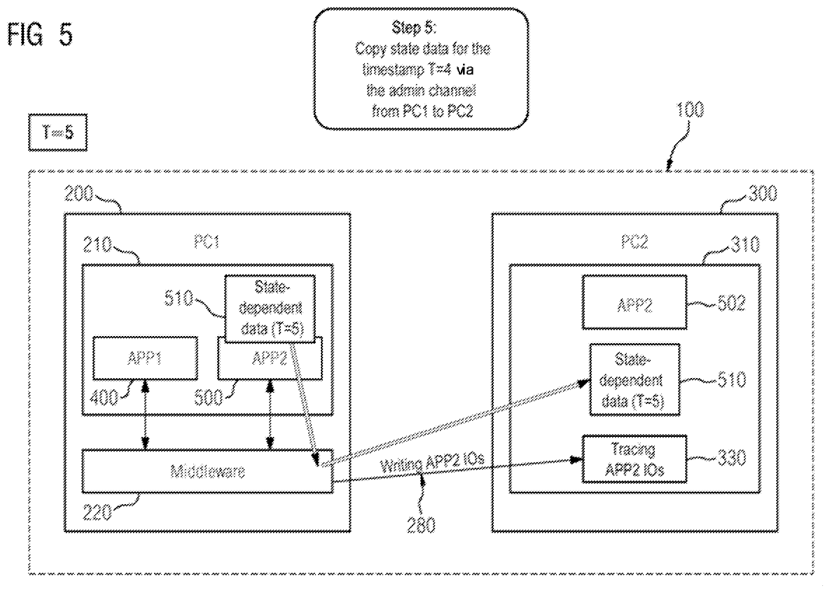

FIG. 5 now shows the course of a 5^{th} work step at the time T=5, at which the state data 510 of the first instance of the second software application 500, currently up to date at the time T=5, are transferred first via the open control channel from the first instance of the second software application 500 to the middleware 220. These state data 510 are then transferred from the middleware 220 to the memory area 310 of the second PC 300 via a communication channel opened to this end. These transfer processes are each symbolized in FIG. 5 by double-headed arrows from the state data 510 of the first instance of the second software application 500 to the middleware 220 and, onward from the middleware 220, to the copy of these state data 510 in the memory area 310 of the second PC 300.

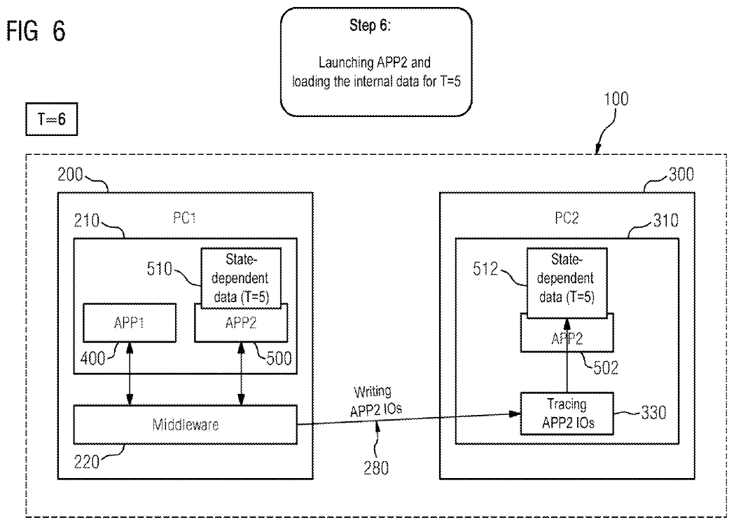

FIG. 6 shows the result of a sixth work step at the time T=6, in which the state data 510 stored on the second PC in the 5^{th} work step are now used as state data 512 belonging to the second instance of the second software application 502 and, to this end, are loaded into the state data area 512 of the second instance of the second software application 502.

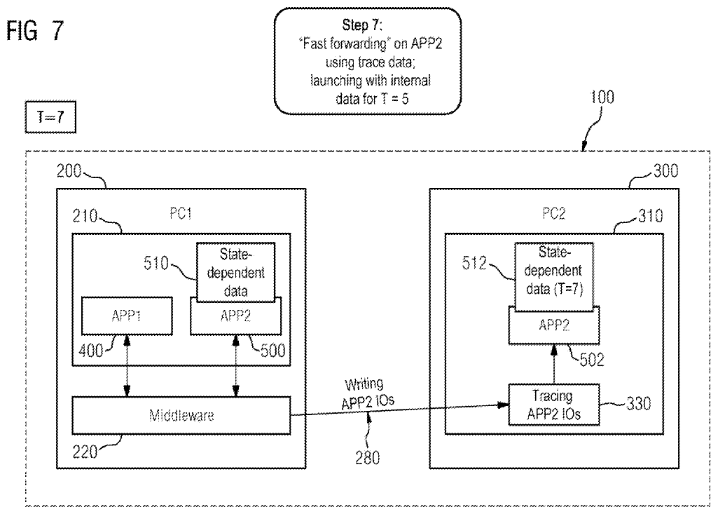

FIG. 7 shows the result of a seventh work step at a time T=7. At the start of this seventh work step, the second instance of the second software application 502 on the second PC 300 is launched using the state data present at the time T=5 on the first instance of the second software application 500 on the first PC 200. In addition to these state data 512, the input and output data corresponding to the time T=5 are also selected from the tracing database 330 and supplied to the second instance of the second software application 502 on the second PC 300. This is symbolized in FIG. 7 by an arrow from the tracing database 330 to the second instance of the second software application 502.

Subsequently, there is an accelerated execution of the second instance of the second software application 502 with a reduced cycle time in this seventh work step. In the process, the state data 512 are then updated at every time in accordance with the usual program execution and the input and output data belonging to this time are taken from the tracing database 330 and are fed to the second instance of the second software application 502. These input and output data exactly correspond to the data that were also present on the first PC 200 at the respective times. Consequently, the second instance of the second software application 502 on the second PC 300 in this way executes completely identically to the way the first instance of the second software application 500 ran on the first PC 200.

This execution can be understood to be a “fast forwarding” of the second instance of the second software application 502 on the second PC 300. This fast forwarding is now performed until, at the time T=7, the first instance of the second software application 500 on the first PC 200 and the second instance of the second software application 502 on the second PC 300 run synchronously. This state is depicted in FIG. 7.

From this time onward, the first instance of the second software application 500 and the second instance of the second software application 502 executes synchronously.

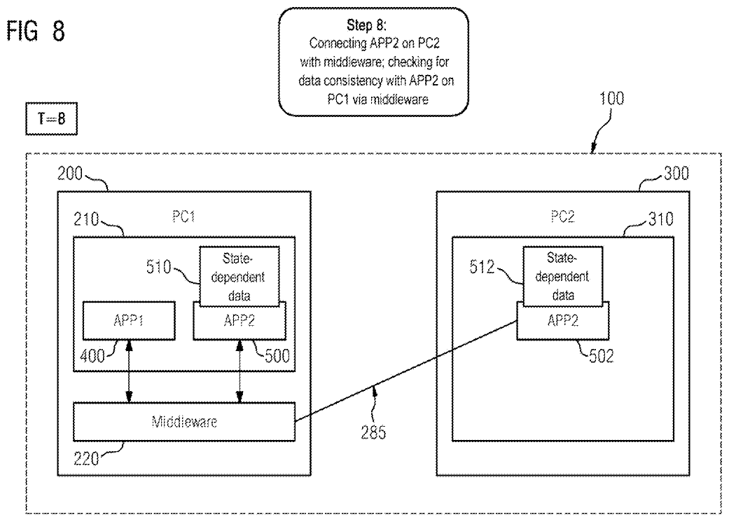

FIG. 8 shows the result of an eighth work step at a time T=8, in which a communications connection 285 is established between the second instance of the second software application 502 on the second PC 300 and the middleware 220 on the first PC 200 and a subsequent check is implemented via the connection to determine whether the data stored in conjunction with the second instance of the second software application 502 on the second PC 300 are consistent with the data stored in conjunction with the first instance of the second software application 500 on the first PC 200.

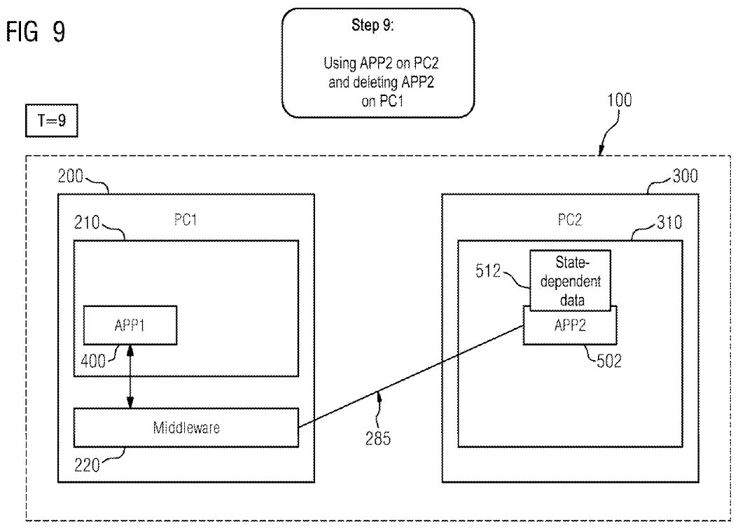

FIG. 9 represents the state after a ninth work step at a time T=9. In this ninth work step, the communication with the first software application 400 is shifted from the first instance of the second software application 500 to the second instance of the second software application 502 situated on the second PC 300. However, this shift is only implemented if the consistency check implemented in the eighth work step was successful.

From this time T=9, the second instance of the second software application 502 on the second PC takes over communication with the first software application 400 via the communications connection 285 between the first 200 and second PC 300 and the middleware 220.

Once this communication has been adopted, the first instance of the second software application 500 on the first PC 200 can be deleted.

Apart from the switchover procedure of the communication from the first instance of the second software application 500 to the second instance of the second software application 502, depicted in the ninth work step in FIG. 9, there was communication between the first software application 400 and one of the two instances of the second software application 500, 502 at all times. Consequently, a virtually continuous communication between the second software application 500, 502 and the first software application 400 is guaranteed in the case of a sufficiently short switchover time. Therefore, an interruption-free movement of the second software application 500, 502 from the first PC 200 to the second PC 300 can be performed in this way.

The otherwise rather more time-consuming steps of transferring the state information 510 and implementing this state information 512 in the newly installed second instance of the second software application 502 are already performed before the switchover as a result of using the tracing database 330 and the fast-forwarding step for the second instance of the second software application 502 in the background, and hence these steps do not lengthen the switchover time.

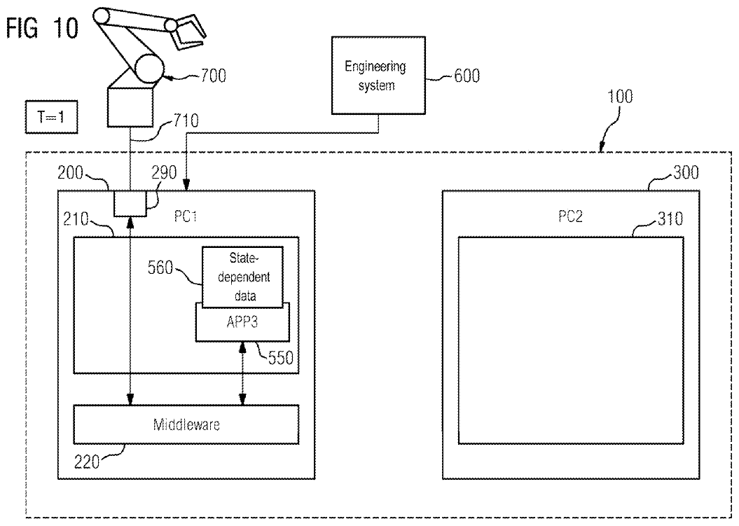

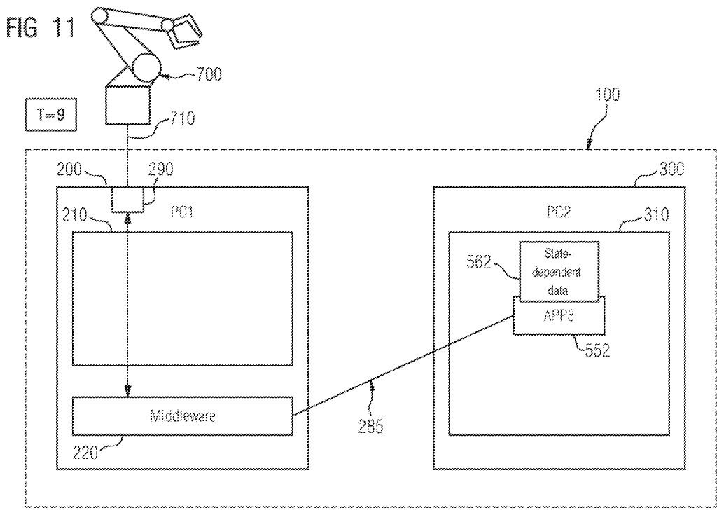

FIGS. 10 and 11 represent a further example for a move of a third software application 550 from the first PC 200 to the second PC 300, the move having been performed in accordance with work steps 1-9 in FIGS. 1-9.

In this case, the communication of a first instance of the third software application 550 with a robot 700 is implemented via the middleware 220, a fieldbus interface 290 of the first PC 200 and a fieldbus line 710 in the example depicted in FIG. 10. Thus, in this case, the first instance of the third software application 550 controls the robot 700 via the communications connection described. With respect to the first instance of the third software application 550, state data 560 are once again stored in the memory area 210 of the first PC 200.

Following the state depicted in FIG. 10, the work steps 1-9 depicted in conjunction with FIGS. 1-9 are also implemented here accordingly in order to transfer the control of the robot 700 from the first instance of the third software application 550 on the first PC 200 to a second instance of the third software application 552 on the second PC 300.

FIG. 10 now shows the result of the ninth work step in accordance with the disclosed embodiments, in the case of which the second instance of the third software application 552 on the second PC 300 has taken over the control of the robot 700 without critical or significant interruption times having occurred during the switchover of the control of the robot 700 from the first instance of the third software application 550 to the second instance of the third software application 552. The second instance of the third software application then once again runs using the state data 562 generated in accordance with the disclosed embodiments.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-11. (canceled)

12. A method for transferring a software application from a first processing device to a second data processing device, the method comprising:
a) executing a first instance of the software application implemented on the first data processing device, a scope of execution of the first instance of the software application within the first data processing device including:
implementing data communication between the first instance of the software application and at least one of a further software application and an apparatus, and
storing state data in relation to at least one of (i) an internal state of the first data processing device and (ii) an internal execution of the first instance of the software application in a first storage device;
b) transferring launch state data available on the first data processing device at a first time to a second storage device communicatively coupled to the second data processing device;
c) launching a second instance of the software application, implemented on the second data processing device, at a second time utilizing the launch state data, the second instance of the software application being subsequently executed on the second data processing device such that, at a third time following the second time, the first instance of the software application on the first data processing device and the second instance of the software application on the second data processing device are executed synchronously; and
d) handing over data communication with the further software application or apparatus from the first instance of the software application implemented on the first data processing device to the second instance of the software application implemented on the second data processing device.

13. The method as claimed in claim 12, wherein input data for the further software application and/or apparatus and/or output data for the further software application and/or apparatus are stored during the data communication during said transferring launch state data of step a);
wherein a tracing process for storing respectively current input data and/or output data in an I/O tracing database is launched in a further method step al) which precedes method step b); and
wherein launching the second instance of the software application during method step c) is further implemented utilizing input and/or output data stored in the I/O tracing database in relation to the first time.

14. The method as claimed in claim 13, wherein at least one of the input date and output data stored in the I/O tracing database are each assigned at least one time value.

15. The method as claimed in claim 12, wherein the data communication with at least one of the further software application and the apparatus is executed without interruptions.

16. The method as claimed in claim 12, wherein the first instance of the software application on the first data processing device and the second instance of the software application on the second data processing device are each run cyclically.

17. The method as claimed in claim 12, wherein the first and second data processing devices each comprise a real-time operating system, execution of the first instance of the software application on the first data processing device and execution of the second instance of the software application on the second data processing device being respectively performed within a scope of the respective real-time operating system of the respective data processing device.

18. The method as claimed in claim 12, wherein the first and the second instances of the software application are each configured for real-time data communication with at least one of the further software application and the apparatus.

19. The method as claimed in claim 12, wherein the data communication is performed utilizing a memory region jointly utilized by the communication partners involved.

20. The method as claimed in claim 12, wherein the state data are labeled within a scope of configuring the first instance of the software application on the first data processing device.

21. The method as claimed in claim 12, wherein the first and second data processing device are each configured as a control device for controlling an apparatus or installation.

22. A data processing system comprising:
a first data processing device; and
a second data processing device,
wherein the data processing system is configured to transfer a software application from the first to the second data processing device by:
a) executing a first instance of the software application implemented on the first data processing device, a scope of execution of the first instance of the software application within the first data processing device including:
implementing data communication between the first instance of the software application and at least one of a further software application and an apparatus, and
storing state data in relation to at least one of (i) an internal state of the first data processing device and (ii) an internal execution of the first instance of the software application in a first storage device;
b) transferring launch state data available on the first data processing device at a first time to a second storage device communicatively coupled to the second data processing device;
c) launching a second instance of the software application, implemented on the second data processing device, at a second time utilizing the launch state data, the second instance of the software application being subsequently executed on the second data processing device such that, at a third time following the second time, the first instance of the software application on the first data processing device and the second instance of the software application on the second data processing device are executed synchronously; and
d) handing over data communication with the further software application or apparatus from the first instance of the software application implemented on the first data processing device to the second instance of the software application implemented on the second data processing device.
